(19) United States
(12) Patent Application Publication
(10) Pub. No.: US 2011/0139573 A1
(43) Pub. Date: Jun. 16, 2011

(54) AUTOMATIC PRODUCT-DISPENSING MACHINE

(76) Inventor: Santiago Yelamos Nieto, Llinars del Valles (ES)

(21) Appl. No.: 13/057,313

(22) PCT Filed: Jul. 28, 2009
(86) PCT No.: PCT/ES2009/000398

§ 371 Date: Feb. 28, 2011

(30) Foreign Application Priority Data
Aug. 8, 2008 (ES) P 200802438 8

(51) Int. Cl. G07F 11/72; G07F 5/08

(52) U.S. Cl. 194/202; 194/232

(57) ABSTRACT

The product is released by means of a mechanical push-button that releases a ratchet system (18) where the coins rest and, once the counterweight (20) has been overcome, the locking system is composed of a series of balls (12), spacer cylinders (3), compression springs (5) and a stop shaft (11) inserted inside a cylindrical tube (1) which, being unlocked, allow the insertion, between said balls (12), of a pusher rod (7), thereby allowing the movement of the rod (7) responsible for releasing the stacked product. A shaft stop (17) prevents malicious dual actuation, since there is no space between the pusher rod (7) inserted between the balls (12). Unlocking the shaft with return lever (6) effects a deposit in the collection box. The return comprises a return spring (16) that actuates the shaft with return lever (6) and the latter in turn actuates the push-button rod (7), the machine thereby being readied for the next operation.

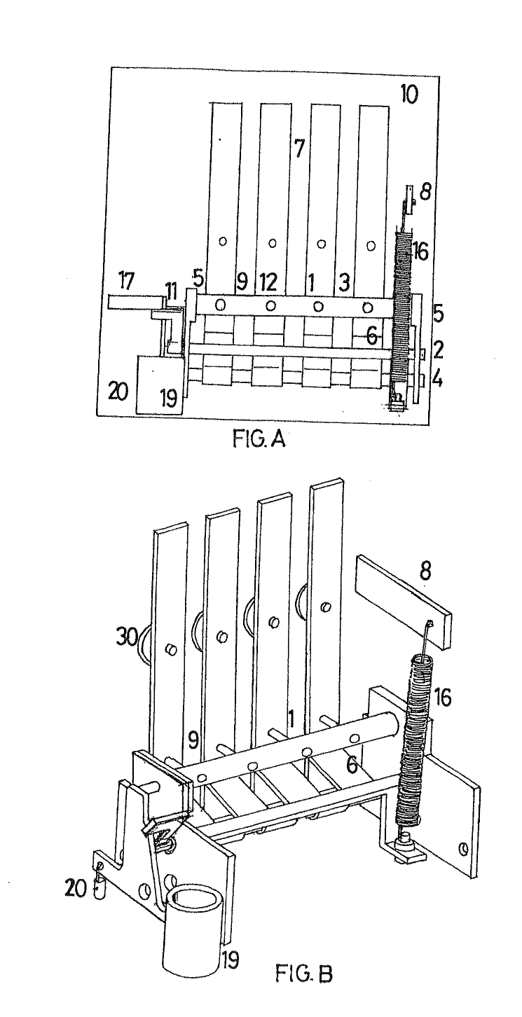

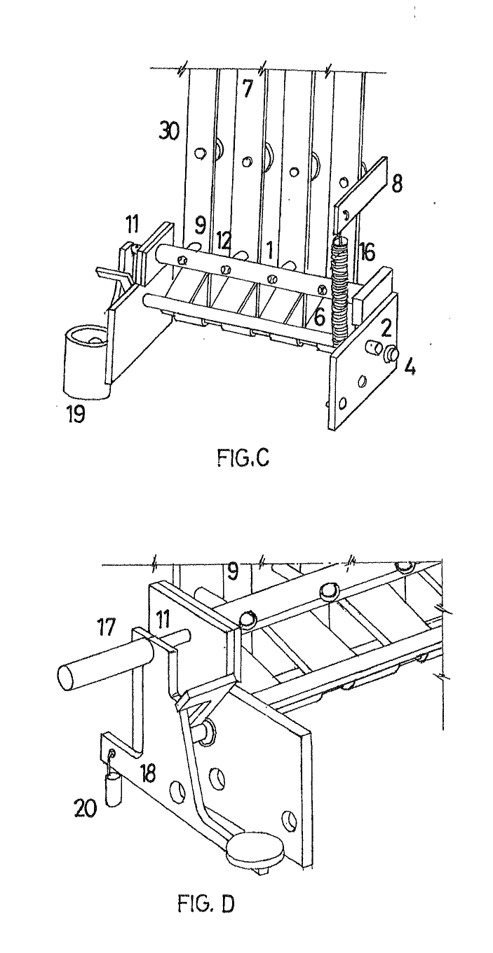

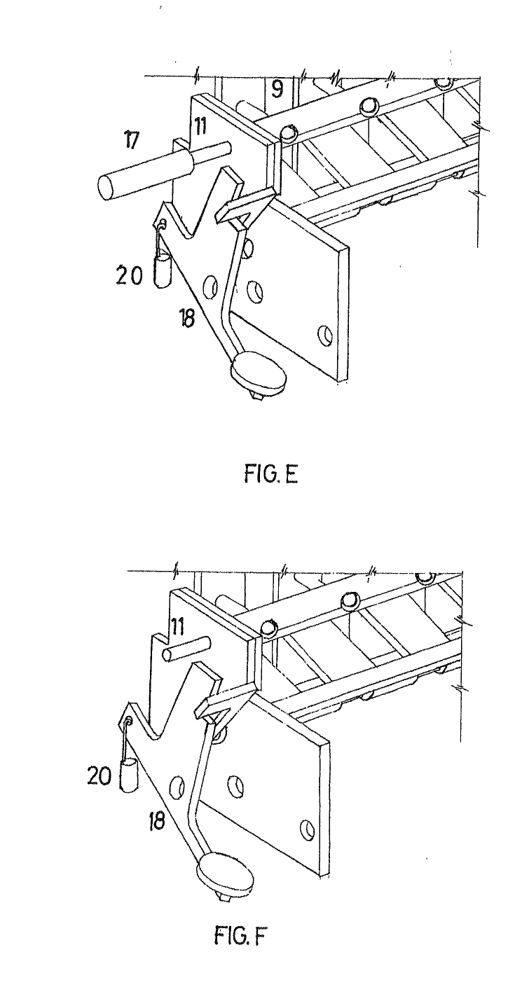

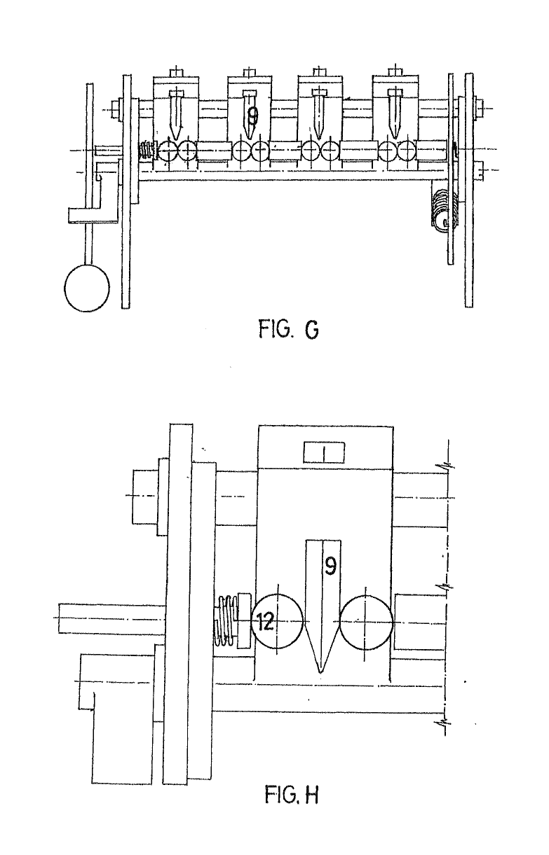

The purpose of the present specification is to state the object which grants the exclusive industrial and commercial exploitation rights in the national territory in accordance with the current legislation of a PATENT OF INVENTION which, as indicated by the title, is a product vending machine, automatic, which can be actuated by the system of push-buttons.

The present invention particularly relates to machines with push-buttons, equipped with a series of containers wherein the products to be sold (sweets, chewing gum, condoms, etc.) are stacked and are removed after inserting the quantity of coins required, through a slot suitable for this use, subsequently pressing the push-button of the product chosen, and which normally is indicated on the upper part of the same push-button.

Generally, these types of machines, of small dimensions, use revolving type mechanisms, wherein the coins are inserted in a cylindrical loader and the user alternatively turns the lever after inserting each coin, until arriving at the stipulated purchasing price, when, after turning the lever again, the product falls into the collection tray.

The aim of the invention is to improve upon the aforementioned machines by means of the introduction of fundamental and radical improvements both in the unlocking and locking mechanism of the system and the release of coins, facilitating the use thereof for the client.

In the present machine, the removal of the product is carried out by means of levers actuated by the same push-button (one for each column of stacked product) in a single movement (the motion of pushing the push-button), The system of balls and spacers described below prevents two or more push-buttons from being pushed at the same time.

A sample of the product which is bought upon pushing it is shown on top of each push-button, with an indication of the sale price, coins which must be inserted in the corresponding slot.

Once the product is selected, and the indicated coins inserted, the push- button corresponding to the desired product is pushed, then the product selected appears in the collection tray, where it can be comfortably withdrawn by the user.

With the aim of facilitating a more exact interpretation of the machine of the present invention, a practical form of this specification is represented in the complementary attached drawings for its industrial production which is solely included with informative information and, therefore, is non-limitative of the invention.

In the aforementioned drawings,

fig. A represents a front view of the actuation, locking and dispensing mechanisms of the product, with the numbered components, the product storage systems and product collection tray have not been included;

figs. B and C both show perspectives of the machine without the cover, where the interior mechanisms thereof can be observed;

figs. D and E show a perspective view of the dispensing operation of the actuation of dispatching the product;

figs. F and G shows a close-up plan view of the dispensing position and operation of the actuation of dispatching the product.

As shown in figure A, exteriorly the machine is constituted in parallelepiped form, perfectly designed to be hung on a wall, on its front it has the push-buttons with information about the products which it sells, the corresponding prices and the type of coins which must be inserted through the corresponding slot.

The PUSH-BUTTONS (30) are situated on the lower part of the machine, and under these are the product collection TRAY, and the coin box with its corresponding actuation push-button.

The mechanism can be observed in figures B and C without the external enclosing METAL FRAME (10), and the interior components and mechanisms which determine its automatic operation are shown. The components are listed below:
1 CYLINDRICAL TUBE
2 FLAT BAR (×2)
3 SPACER CYLINDERS (1 for each PUSH-BUTTON) housed inside the CYLINDRICAL TUBE
4 PUSH-BUTTON SHAFT
5 COMPRESSION SPRING (×2)
6 RETURN LEVER
7 PUSHER ROD
8 FLAT SUPPORT BAR FOR RETURN SPRING
9 BALL PUSHER
10 FRAME
11 STOP SHAFT
12 BALLS (2 for each PUSH-BUTTON)
16 RETURN SPRING
17 SHAFT STOP
18 RATCHET SYSTEM
19 COIN BOX
20 COUNTERWEIGHT
30 PUSH-BUTTON

The machine includes a METAL FRAME (10), where the following have been fastened by means of welding or riveting:
The COIN INSERTION system, not included in this specification.
The PRODUCT STORAGE AND STACKING system.
The COIN COLLECTION BOX
The COLLECTION TRAY for the products sold.
Two FLAT BARS (2) responsible for supporting the UNLOCKING AND LOCKING system.
A RETURN SPRING FLAT BAR (8)
A SHAFT STOP (17)

fastened on the FLAT BARS (2) are the RATCHET SYSTEM (18), the RETURN LEVER (6), the PUSH-BUTTON SHAFT (4) whereon the PUSHER ROD (7) has its point of rotation and the CYLINDRICAL TUBE (1), the latter including in its interior with the sequence specified in drawing F, the STOP SHAFT (11), the SPACER CYLINDERS (3), the BALLS (12) and the COMPRESSION SPRINGS (5).

The RATCHET SYSTEM (18) on the opposite end of that of the coin collection has a cylindrical drill hole where the COUNTERWEIGHT (20) is placed.

The PUSHER ROD (7) has incorporated and solidly joined thereto the BALL PUSHER (9) and the corresponding PUSH-BUTTON (30). The cylindrical piece of plastic material, COIN BOX (19), is attached to one of the FLAT BARS (2), exactly the one closest to the RATCHET SYSTEM (18).

Operation

The Client inserts the coins through the SLOT featured by the COIN INSERTION SYSTEM in the front part of the machine, which is the moment of the situation described in drawing D.

The coins, inserted one by one, fall and are deposited in the COIN BOX (19), until reaching the exact amount, when the weight of the COUNTERWEIGHT (20) is overcome and the RATCHET SYSTEM (18) rotates, freeing the possible movement of the STOP SHAFT (11) (see drawing F), in no case shall the RATCHET SYSTEM (18) exceed the angle of rotation described by the buffer which the RETURN LEVER (6) has on its end.

At this moment, the Client can press the PUSH-BUTTON (30) of the material desired, upon pushing it the PUSHER ROD (7) is actuated, by leverage, the BALL

PUSHER (9) of the desired product is introduced between the adjoining BALLS (12) (See drawing H), producing a movement in the SPACER CYLINDERS (3) and in the adjoining BALLS (12), which overcoming the force of the COMPRESSION SPRINGS (5) make the STOP SHAFT (11) move until its end position.

This same movement of the PUSHER ROD (7) is collected by the RETURN

LEVER (6) which turns pushed by the PUSHER ROD (7), overcoming the force of the RETURN SPRING (16), with this small movement of the RETURN LEVER (6) (buffer of the RATCHET SYSTEM (18) where, at this moment, where we have deposited the coins) permits us to unload the coins in the COIN COLLECTION BOX and release the stacked sold product from storage, and which is sent to the product COLLECTION TRAY.

Given the existence of the SHAFT STOP (17), the movement of the SPACERS (3), BALLS (12) and STOP SHAFT (11) is limited preventing the insertion of a second BALL PUSHER (9), preventing the removal of two products simultaneously.

Once the PUSH-BUTTON is no longer being pushed, the system returns to its initial position with the help of the RETURN SPRING (16) and the COMPRESSION SPRINGS (5).

Note

The nature of the inventions having been sufficiently described, as well as a practical form for its industrial production, it only must be additionally noted that it is possible to introduce modifications of shape, material and arrangement in the array and constitutive parts thereof as long as said modifications do not result in a substantial variation thereof.

The applicant reserves the right to extend this claim to foreign countries, claiming the same priority of the present application to the protection of the International Convention for the Protection of Industrial Property.

The applicant also reserves the right to introduce as many improvements in the present invention as they wish, by means of applying for the corresponding Certificates of Addition in the manner stipulated by the Law. The Patent of Invention which is applied for, in accordance with the current Legislation, must be in regard to “AUTOMATIC PRODUCT VENDING MACHINE” according to the essential characteristics of the following:

1. Automatic product vending machine, which is characterized in that the product dispensing system is actuated by means of a mechanical push-button, by freeing the RATCHET SYSTEM (18) where the coins deposited rest and once overcoming the COUNTERWEIGHT (20), the locking system.

2. Automatic product vending machine, according to claim 1, characterized in that the locking system is composed of a series of BALLS (12), SPACER CYLINDERS (3), COMPRESSION SPRINGS (5) and STOP SHAFT (11), inserted inside a CYLINDRICAL TUBE (1) which, being unlocked, allow the insertion between the BALLS (12) of a PUSH-BUTTON SHAFT (4) and make the movement of the PUSHER ROD (7) possible, which is responsible for releasing the product from its stacked storage place.

3. Automatic product vending machine, according to claim 1, characterized in that the locking system stated in claim 2, with the disposal of the SHAFT STOP (17) prevents malicious dual actuation, since there is no space for a second PUSHER ROD (7) inserted between the BALLS (12).

4. Automatic product vending machine, according to claim 1, characterized in that the deposit system in the COIN COLLECTION BOX is carried out after unlocking the RETURN LEVER (6).

5. Automatic product vending machine, according to claim 1, characterized in that the return system is composed of a RETURN SPRING (16), that actuates the RETURN LEVER (6) and the latter, in turn, actuates the PUSHER ROD (7), the machine therefore being readied for the next operation.

6. “AUTOMATIC PRODUCT VENDING MACHING”
As substantially described in the present specification which is made up of 5 type-written sheets on a single side and attached drawings.
